(19) United States
(12) Patent Application Publication
(10) Pub. No.: US 2016/0303609 A1
(43) Pub. Date: Oct. 20, 2016

(54) APPARATUS AND METHOD FOR SOLID WASTE SEPARATION

(71) Applicant: AnaeCo Limited, Bentley (AU)

(72) Inventors: Ryszard Stanislaw RUDAS, Darlington (AU); Janusz Krzysztof FULARA, Kallaroo (AU); Martin Richard GRAVETT, Salisbury (AU); Tomasz RUDAS, Darlington (AU)

(73) Assignee: ANAECO LIMITED, Bentley, WA (US)

(21) Appl. No.: 14/783,635

(22) PCT Filed: Apr. 11, 2014
(86) PCT No.: PCT/AU2014/000411

§ 371 Date: Oct. 9, 2015

(30) Foreign Application Priority Data
Apr. 12, 2013 (AU) 2013204344

(51) Int. Cl. B07B 1/22; B07B 1/52; B07B 1/42

(52) U.S. Cl. CPC B07B 1/22; B07B 1/42; B07B 1/528; B07B 2230/01

(57) ABSTRACT

An apparatus (10) for solid waste separation comprising at least two rotatable trommel sections (12, 14, 16) arranged such that solid waste to be separated can be passed through one trommel section and into the other, the trommel sections (12, 14, 16) each having provided therein screens (144, 146, 148, 150) through which screened material may pass, wherein at least two of the trommel sections (12, 14, 16) are capable of rotating at different relative speeds. Each of a trommel section transfer sealing means, a sealing arrangement for two components between which there is relative rotation, a rotating screen cleaning means, a trommel support arrangement, and a method for the separation of solid waste are also described.

### FIELD OF THE INVENTION

The present invention relates to an apparatus and method for solid waste separation. More particularly, the apparatus and method of the present invention are intended for use in the separation of mixed municipal solid waste.

A number of additional components or features particularly useful in the context of methods for solid waste separation are also described, including each of a trommel section transfer sealing means, a sealing arrangement for two components between which there is relative rotational movement, a rotating screen cleaning means, and a trommel support arrangement.

### BACKGROUND ART

The treatment of mixed municipal solid waste (“MSW”) presently most typically comprises passing that waste to some form of separation process by which organic materials therein are first separated, as much as possible, from inorganic materials. This initial separation step is invariably a size based separation, with organic material typically being smaller or softer than much of the inorganic material. The organic materials are subsequently directed, at least in part, to a biological stabilisation or degradation process, whilst the inorganic material is sorted into recyclables and non-recyclables, the latter being passed to landfill. The product of the biological stabilisation or degradation process is ideally a compost material and/or a biogas.

The efficiency of such overall processes are highly dependent upon the effectiveness of the manner in which the various separation steps are conducted. Further, the usefulness of the final products of such processes are dependent in large part upon their purity. For example, it is highly preferable if each of glass and grit, film plastics material and both ferrous and non-ferrous materials are removed from the organic material. However, there is invariably a compromise struck between the time taken to achieve a completely efficient result and the cost associated with such. A fast and efficient process for the separation of contaminants from organic material will enable the fast and efficient processing of MSW.

International Patent Application PCT/AU00/00865 (WO 01/05729) describes a process and apparatus in which aerobic and anaerobic processes are combined for the treatment of the organic fraction of MSW. The process and apparatus are characterised at a fundamental level by the sequential treatment of organic waste material in a single vessel, through an initial aerobic step to raise the temperature of the organic waste material, an anaerobic digestion step and a subsequent aerobic treatment step. During the anaerobic digestion step a process water or inoculum containing micro organisms is introduced to the vessel to create conditions suitable for efficient anaerobic digestion of the contents and the production of biogas. The introduced inoculum also aids in heat and mass transfer as well as providing buffer capacity to protect against acidification. Subsequently, air is introduced to the residues in the vessel to create conditions for aerobic degradation. It is further described that the water introduced during anaerobic digestion may be sourced from an interconnected vessel that has undergone anaerobic digestion.

A process such as that described in International Patent Application PCT/AU00/00865 (WO 01/05729) requires effective separation of a variety of materials from the organic fraction of MSW. Such materials include metals, plastics materials, sand, grit, glass and the like. The viability of such processes also requires that the separation of these contaminant materials be fast and efficient.

US Publication 20110008865 A1 discloses a method and apparatus for treatment of municipal solid waste in an effort to separate recyclables and to transform solid waste into energy and clean fuel. An initial autoclaving step is integral to the method and is aimed at breaking down fibre to fibre bonds of cellulosic material. A single trommel is used for separation and produces a homogenous organic fraction that is mixed with water from sludge dewatering. The organic stream undergoes fermentation and thermophilic anaerobic digestion. The methane produced is used to generate heat and electrical energy for plant operation. A thickened dewatered sludge is produced by the digesters that is intended as a feedstock for pyrolysis. The oversize from the trommel separation step is passed to steps in which metals, aluminium, glass and plastics are removed. The separation steps employed are coarse and relatively inefficient, including the fact that it is only the ultimate oversize from the trommel that is subjected to a number of the separation steps.

The method for solid waste separation of the present invention has as one object thereof to overcome substantially the abovementioned problems of the prior art, or to provide a useful alternative thereto.

The preceding discussion of the background art is intended to facilitate an understanding of the present invention only. The discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided an apparatus for solid waste separation comprising at least two rotatable trommel sections arranged such that solid waste to be separated can be passed through one trommel section and into the other, the trommel sections each having provided therein screens through which screened material may pass, wherein at least two of the trommel sections are capable of rotating at different relative speeds.

Preferably, the screen in a first trommel section is finer than the screen provided in a second trommel section.

Still preferably, a first portion of the screen in the first trommel section is substantially solid, being substantially without apertures.

In one form of the present invention the apertures in the screen of the first trommel section are less than or equal to about 60 mm diameter.

Preferably, the apertures in the screen of the first trommel section are about 40 mm.

Preferably, the first trommel section has provided therein immediately adjacent the first end thereof a screw bladed portion whereby waste entering the first trommel section is moved a distance into the first trommel section at first instance.

Still preferably, the screw bladed portion is provided in a first solid portion of the first trommel. The remainder of the screen in the first trommel section is provided with apertures, as is the screen of the or each subsequent trommel.

Preferably, a final trommel section has provided therein a length of terminal screen that is coarser than the screen utilised in the remainder of the final trommel section and other trommel sections.

In one form of the present invention there are provided three trommel sections. Preferably, the waste discharged through the screens provided in each trommel in such an arrangement is about 20%, 30% and 30% by volume of the waste fed to the trommels respectively, the remainder being passed from the final trommel.

Preferably, the apertures in the final trommel section are less than or equal to about 300 mm.

Preferably, the trommel sections are provided with internal lifting means whereby the waste passing therethrough is lifted as the trommel sections rotate.

Still preferably, one or more of the trommel sections may be arranged at a decline to facilitate passage of waste therethrough.

The first trommel is preferably provided with spray means whereby the solid waste passing therethrough may be wetted or moistened. The solid waste is preferably wetted or moistened as it falls within the first trommel as a result of the rotation thereof.

Preferably, the rotation of each trommel section is separately driven.

Still preferably, each trommel section is supported on four drive wheels, whereby the load of the trommel section is shared therebetween. Each of the four drive wheels is driven individually in a synchronised manner.

The drive wheels are preferably arranged in pairs, between and on which the trommel section is located, the drive wheels being supported on support frames. The support frames further have located thereon idler means and thrust roller means, wherein the idler means allows the weight of the trommel section to be borne thereby and the trommels lifted, relieving the drive wheels of the weight of the trommel section, and the thrust roller means operating to impart passive resistance to aid in locating the trommel section on the drive wheels.

A parking lock means is further provided whereby the drive wheels may be relieved of weight when the trommel sections are not rotating and are at rest, thereby preventing flat spots developing on the drive wheels.

Still preferably, the first trommel section rotates at a faster rate than the second trommel section.

In one form of the present invention the first trommel section rotates at a speed of up to about 25 rpm. Preferably, the first trommel section rotates at a speed of about 9 to 16 rpm. The second trommel section rotates at a speed of less than about 9 to 16 rpm.

The apparatus for solid waste separation further comprises transfer sealing means provided between the trommel sections.

Preferably, the transfer sealing means between trommel sections facilitates the rotation of the trommel sections at relatively different speeds whilst maintaining the integrity of the seal.

In one form, the transfer sealing means comprises an annular flexible member retained between adjacent trommel sections and about the circumference thereof. The transfer sealing means further comprises a flexible retaining member and a locating member, each extending about the circumference of the trommel sections, wherein the locating member fixes the flexible retaining member in position whereby the flexible retaining member locates and retains the annular flexible member in position.

The annular flexible member of the transfer sealing means is retained by the flexible retaining member in a circumferential recess provided between adjacent trommel sections. The circumferential recess is defined by a channel provided in a rear end of one trommel section, the locating member and the flexible retaining member.

In a further form, the transfer sealing means may be provided in the form of the first end sealing arrangement described hereinbelow, wherein adjacent trommel sections constitute both first and second components.

The apparatus for separation of solid waste further comprises a conveyor means provided substantially underneath the trommel sections such that material screened by the trommel sections may be received on the conveyor means.

A first end of the first trommel is provided with an end cap in which is provided a slot by which municipal solid waste may be fed to the first trommel. The first end of the first trommel is further preferably provided with a first end sealing arrangement. The first end sealing arrangement facilitates the rotation of a first component, for example the first trommel, relative to a second component, for example the end cap.

Preferably, the first end sealing arrangement comprises a raised annular portion provided on the first end of the first trommel and a dual leaf annular member provided on the end cap, wherein the raised member is received between the leaves of the dual leaf annular member thereby forming a substantially tight seal.

The apparatus for solid waste separation of the present invention preferably further comprises one or more screen cleaning means.

Preferably, the screen cleaning means are arranged to impinge upon the screens of the or each trommel thereby removing material that may be clogging or otherwise interfering with the operation of same.

Still preferably, the screen cleaning means comprises an elongate paddle wheel on which is provided a plurality of resilient screeds, the paddle wheel being rotatable about its length such that the screeds impinge upon the screens of the trommel section in a manner that facilitates the wiping of material from the screens.

In one form of the invention the elongate paddle wheel rotates in a direction opposed to that of the screens. In a further form of the present invention it is envisaged that the paddle wheel and trommel may rotate in the same direction but at different speeds such that the wiping of material from the screens is achieved.

In accordance with the present invention there is further provided a trommel section transfer sealing means whereby a seal may be provided between trommel sections that rotate at relatively different speeds whilst maintaining the integrity of the seal, the transfer sealing means comprising an annular flexible member retained between adjacent trommel sections and about the circumference thereof, the transfer sealing means further comprising a flexible retaining member and a locating member, each extending about the circumference of the trommel sections, wherein the locating member fixes the flexible retaining member in position whereby the flexible retaining member locates and retains the annular flexible member in position.

Preferably, the annular flexible member of the transfer sealing means is retained by the flexible retaining member in a circumferential recess provided between adjacent trommel sections.

Still preferably, the circumferential recess is defined by a channel provided in a rear end of one trommel section, the locating member and the flexible retaining member.

In accordance with the present invention there is still further provided a sealing arrangement whereby the connection of a first component to a second component, between which there is relative rotational movement, may be achieved in a substantially sealed manner, the sealing arrangement comprising a raised annular portion provided on one component and a dual leaf annular member provided on the other component, wherein the raised member is received between the leaves of the dual leaf annular member thereby forming a substantially tight seal.

In one form of the sealing arrangement of the present invention, one component is stationary and the other component able to rotate relative thereto.

Preferably, the rotating component is a trommel.

In accordance with the present invention there is still further provided a rotating screen cleaning means comprising an elongate paddle wheel on which is provided a plurality of resilient screeds, the screen cleaning means are arranged to impinge upon the or each screen to be cleaned in a manner that facilitates the wiping of material from the or each screen that may be clogging or otherwise interfering with the operation of same.

In one form of the present invention the elongate paddle wheel rotates in a direction opposed to that of the or each screen to be cleaned. In a further form of the present invention it is envisaged that the paddle wheel and the or each screen to be cleaned may rotate in the same direction but at different speeds such that the wiping of material from the screens is achieved.

Preferably, the or each rotating screen is provided on a trommel.

In accordance with the present invention there is still further provided a trommel support arrangement comprising four drive wheels for each rotating section of trommel to be supported, the drive wheels being supported on a support frame, whereby the load of the trommel section is shared therebetween, the support frames further having located thereon idler means and thrust roller means, wherein the idler means allows the weight of the trommel section to be borne thereby and the trommels lifted, relieving the drive wheels of the weight of the trommel section, and the thrust roller means operating to impart passive resistance to aid in locating the trommel section on the drive wheels.

The drive wheels are preferably arranged in pairs, between and on which the trommel section is located. Each of the four drive wheels is preferably driven individually in a synchronised manner.

Preferably, a parking lock means is further provided whereby the drive wheels may be relieved of weight when the trommel sections are not rotating and are at rest, thereby preventing flat spots developing on the drive wheels.

In accordance with the present invention there is still further provided a method for the separation of solid waste, the method comprising the steps of passing a solid waste to a series of at least two rotating trommel sections, the trommel sections being arranged such that the solid waste to be separated can be passed through one trommel section and into the other, the trommel sections each having provided therein screens through which screened material may pass, wherein at least two of the trommel sections are capable of rotating at different relative speeds.

Preferably, the method for the separation of solid waste does not require material handling between the trommel sections.

The method of the present invention further comprises the step of wetting or moistening the solid waste. Preferably, the moistening is conducted in a measured and adjustable manner.

Preferably, the method produces each of a fine mixed fraction, a coarse mixed fraction and an oversized mixed fraction from a municipal solid waste.

Still preferably, the fine mixed fraction and the coarse mixed fraction contain both organic and inorganic materials. The oversized mixed fraction may be optionally further separated into at least two sub-fractions, of which the larger fraction will be rejects.

The fine mixed fraction is preferably of a size smaller than or equal to about 60 mm. The coarse mixed fraction is preferably of a size smaller than or equal to about 250 mm. The oversized mixed fraction is preferably of a size greater than 300 mm.

### BRIEF DESCRIPTION OF THE DRAWINGS

The apparatus for solid waste separation of the present invention will now be described, by way of example only, with reference to one embodiment thereof and the following drawings, in which:—

FIG. 1 is a side elevation view of an apparatus for solid waste separation in accordance with the present invention;

FIG. 2 is an upper perspective view of the apparatus for solid waste separation of FIG. 1;

FIG. 3 is a cross section of the side elevation view of the apparatus for solid waste separation of FIG. 1, showing in part a transfer station from which the apparatus of the present invention is fed;

FIG. 4 is a cross section through a sealing arrangement between trommel sections of the apparatus for solid waste separation of FIG. 1;

FIG. 5 is a first end elevation view of the apparatus for solid waste separation of FIG. 1;

FIG. 6 is an end elevation view of an end cap of the first end of the first trommel section of the apparatus for solid waste separation of FIG. 1;

FIG. 7(A) is a side elevation and partial cross section view of the end cap of FIG. 6 showing its interaction with the first trommel section by way of the first end sealing arrangement;

FIG. 7(B) is a side elevation cross section view of the first end sealing arrangement of FIG. 7(A);

FIG. 8 is a cross section end view of a trommel section showing lifting bars provided on the inside thereof;

FIG. 9 is an end elevation view of the apparatus for solid waste separation of FIG. 1, showing each of the driving means, idler means and thrust roller means;

FIG. 10 is an upper perspective view of one of each of the driving means, idler means and thrust roller means of the apparatus for solid waste separation of FIG. 1, shown with the shell of the trommel removed;

FIG. 11 is a partial end elevation view of the apparatus for solid waste separation of FIG. 1, showing the interaction of the driving means, idler means and parking lock means with the trommel shell, in addition to the conveyor provided thereunder;

FIG. 12 is a partial end elevation view of the apparatus for solid waste separation of FIG. 1, showing the interaction of the driving means, idler means, parking lock means and thrust roller means with the trommel shell, in addition to the conveyor provided thereunder;

FIG. 13 is a top plan view of the thrust roller means of FIG. 9;

FIG. 14 is a side elevation view of the thrust roller means of FIG. 9;

FIG. 15 is a cross section side view through the thrust roller mounting of the thrust roller means of FIG. 9;

FIG. 16 is a cross section side view through a single thrust roller of the thrust roller means of FIG. 9;

FIG. 17 is a lower perspective view of the thrust roller means of FIG. 9;

FIG. 18 is an upper perspective view of the idler means of FIG. 9;

FIG. 19 is a cross section plan view of the idler means of FIG. 9;

FIG. 20 is a partial side elevation view of the idler means of FIG. 9;

FIG. 21 is an upper perspective view of the parking lock means of FIG. 9;

FIG. 22 is an end partial cross section elevation view of a screen cleaning means of the apparatus for solid waste separation of the present invention;

FIG. 23 is a plan view of a paddle wheel portion of the screen cleaning means of FIG. 22;

FIG. 24 is an upper perspective view of the paddle wheel portion of the screen cleaning means of FIG. 22;

FIG. 25 is an end elevation view of the paddle wheel portion of the screen cleaning means of FIG. 22;

FIG. 26 is an upper perspective view of the screen cleaning means of FIG. 22;

FIG. 27 is an end elevation view of the screen cleaning means of FIG. 22;

FIG. 28 is a top plan view of the screen cleaning means of FIG. 22;

FIG. 29 is a side elevation view of the screen cleaning means of FIG. 22;

FIG. 30 is a first upper perspective view of the idler and drive assemblies of the screen cleaning means of FIG. 22;

FIG. 31 is a second upper perspective view of the idler and drive assemblies of the screen cleaning means of FIG. 22;

FIG. 32 is a first upper perspective view of the idler assembly of the screen cleaning means of FIG. 22; and

FIG. 33 is a second upper perspective view of the idler assembly of the screen cleaning means of FIG. 22.

### BEST MODE(S) FOR CARRYING OUT THE INVENTION

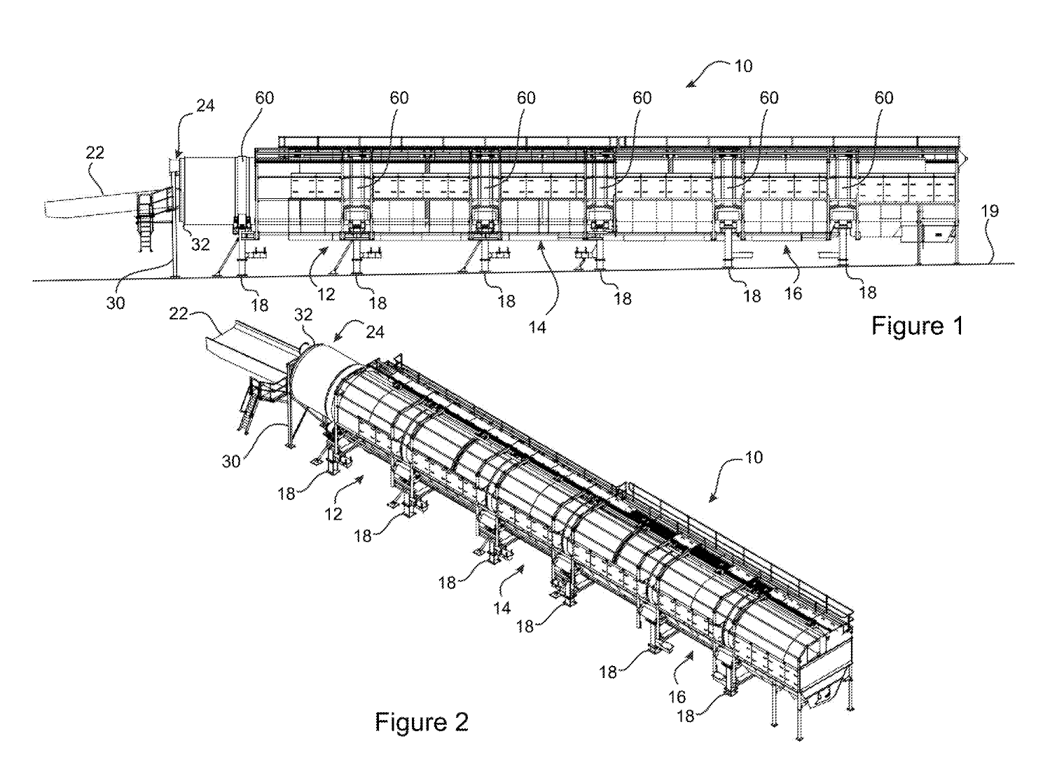

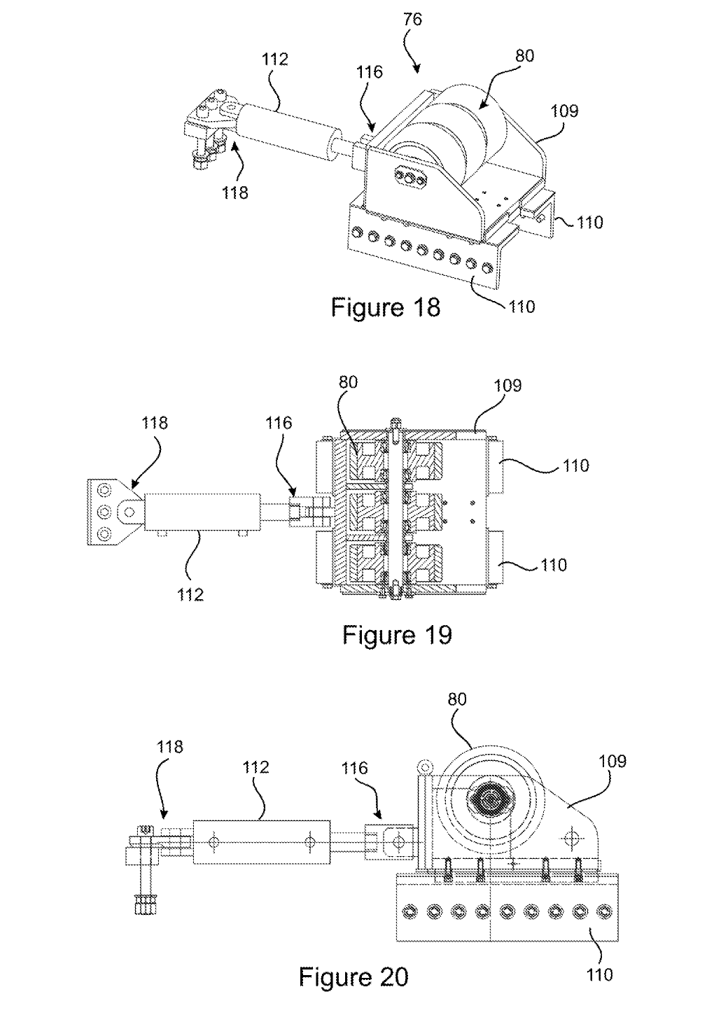

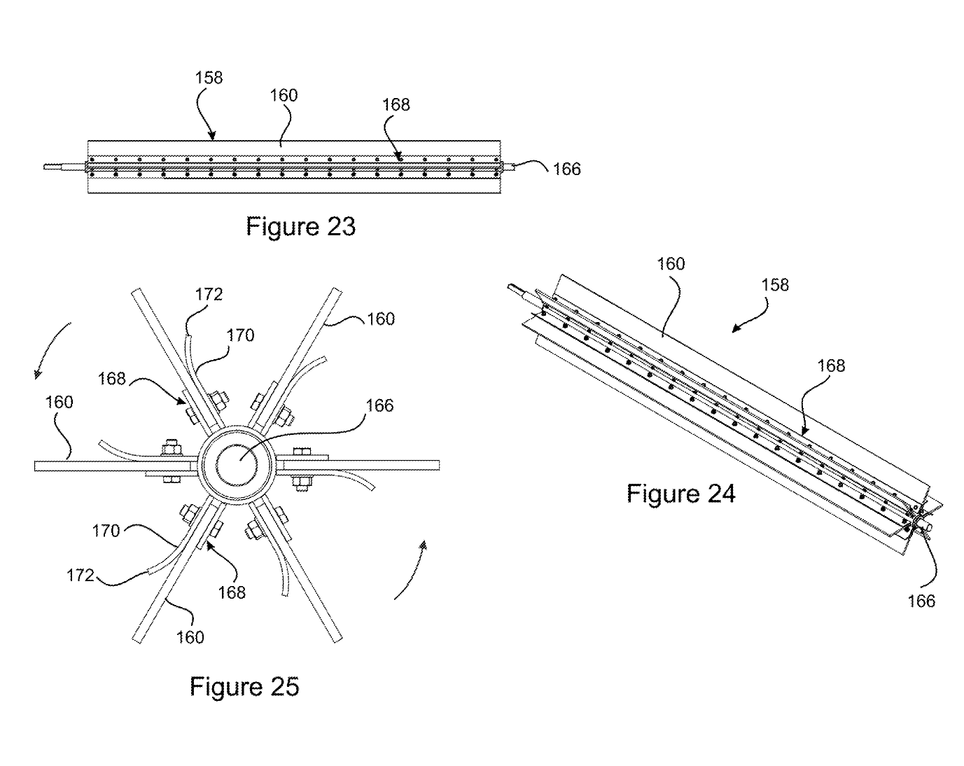

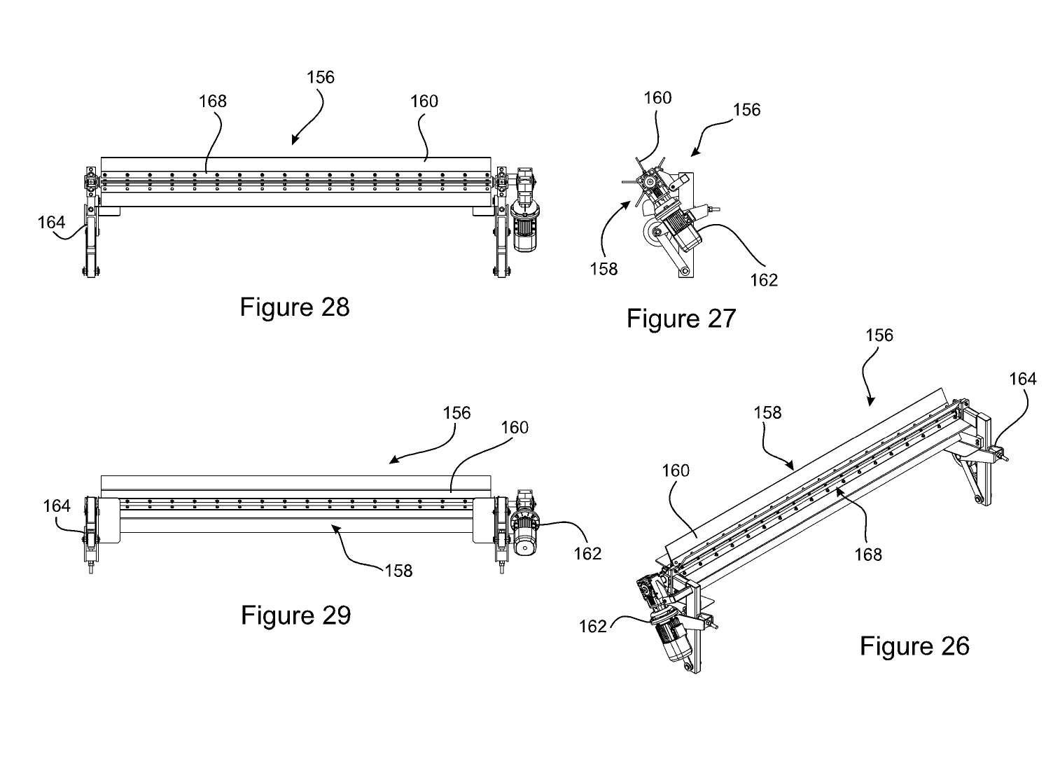

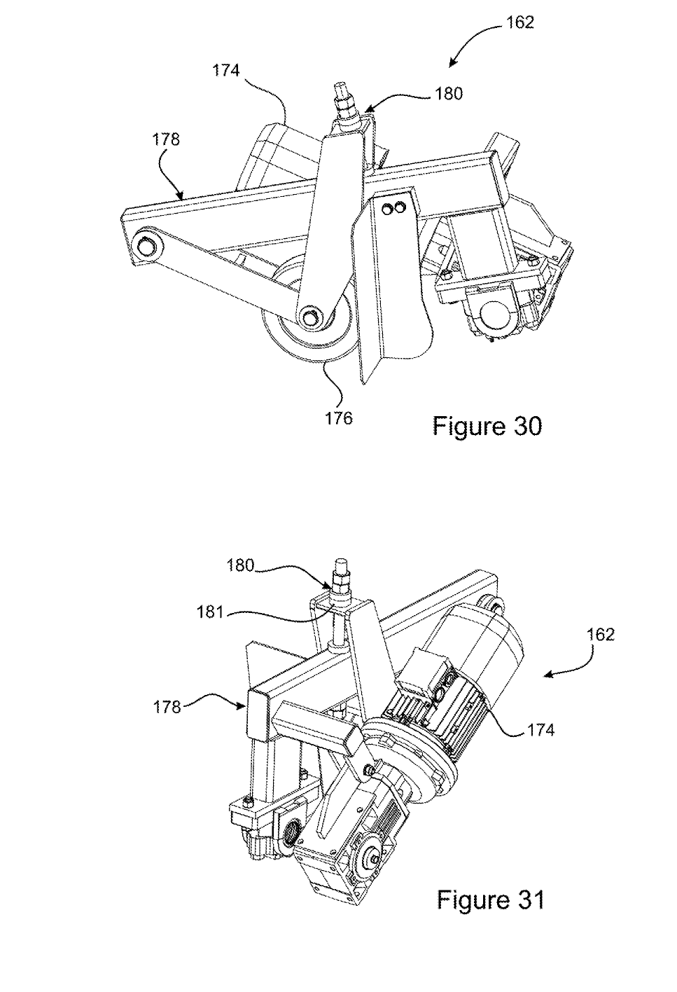

In FIGS. 1 to 33 there is shown an apparatus 10 for solid waste separation comprising at least two rotatable components or trommel sections, for example a first trommel section 12, a second trommel section 14 and a third trommel section 16. Solid waste, for example municipal solid waste (“MSW”) to be separated, is passed from one trommel section to another. The trommel sections 12, 14 and 16 may collectively be referred to as a trommel train.

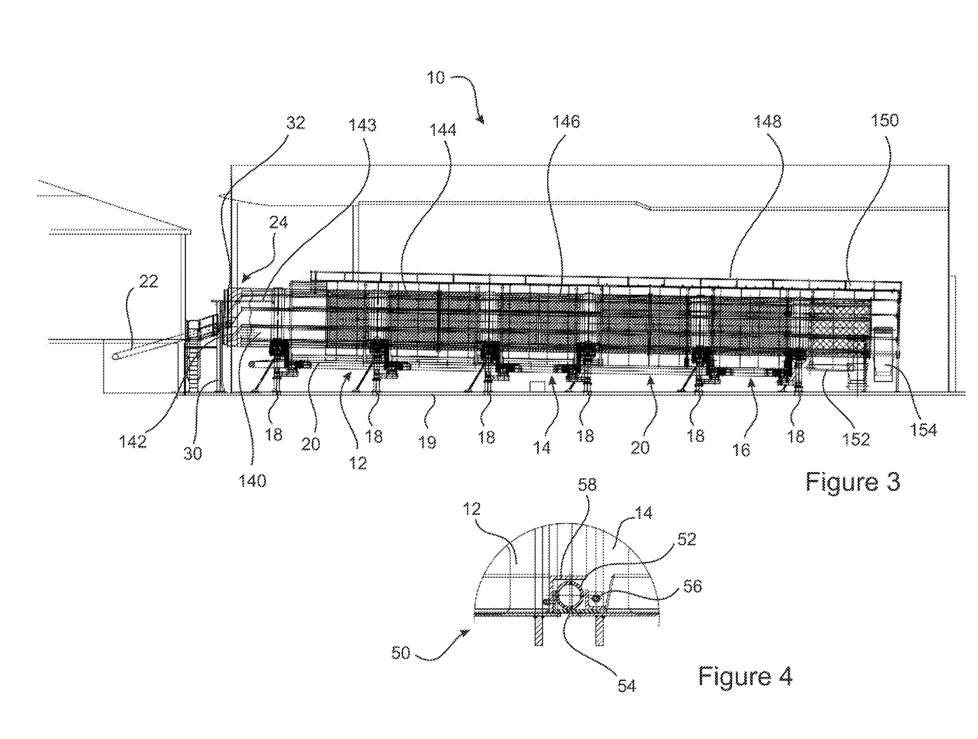

The trommel train is supported on a series of trommel support arrangements comprising in part support frames 18 that hold the trommel train above a surface 19. The trommel train is further supported by the support frames above an underslung conveyor 20 that is positioned substantially underneath the trommel train, best seen in FIG. 3. The conveyor 20 extends along almost the entire length of the trommel train. As the conveyor 20 is able to be provided underneath the trommel train the footprint of the apparatus 10 is kept to a minimum.

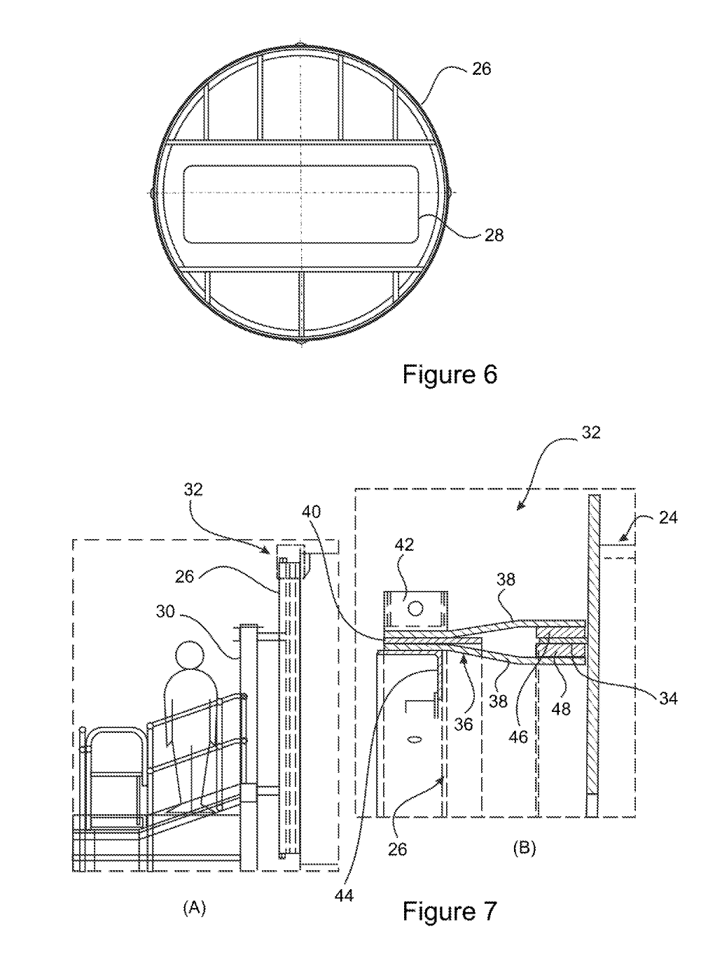

A conveyor 22 is arranged so as to feed MSW to a first end 24 of the first trommel 12, as shown in FIGS. 1 to 3. The first end 24 of the first trommel 12 has provided thereon a stationary component, for example an end cap 26, in which is provided a rectangular aperture 28, best seen in FIG. 6, and through which MSW is fed to the first trommel 12.

The end cap 26 is held rigidly in place by way of a frame 30, and does not rotate with the first trommel 12. However, there is provided a first end sealing arrangement 32 between the end cap 26 and the first end 24 of the first trommel 12, best seen in FIG. 7. The first end sealing arrangement 32 facilitates the rotation of the first trommel section 12, a first component, relative to the end cap 26, a second component, whilst maintaining a substantially tight seal therebetween. It is understood that a ‘tight’ seal is one that generally prevents passage of particulate material therethrough and approaches being air-tight, but which may on infrequent occasion permit passage of fluids therethrough.

The first end sealing arrangement 32 comprises a raised annular portion 34 provided on the first end 24 of the first trommel section 12, and a dual leaf annular member 36 provided on the end cap 26, best seen in FIG. 7. The dual leaf annular member 36 extends towards the first end 24 of the first trommel section 12 and receives the raised annular portion 34 between the leaves thereof, thereby forming a substantially tight seal, in turn thereby minimising the transmission of odours.

The dual leaf annual member 36 is in turn comprised of two flexibly resilient and biased annular leaves 38 located about a spacer ring 40. This arrangement is in turn affixed by an outer ring 42 about an inner angle ring 44. A remote end 46 of each leaf 38 has provided thereon a bush 48, between which the raised annular portion 34 is positioned in use, the flexible resilience and biasing of the leaves 38 accentuating the seal created therebetween.

Between each of the trommel sections 12, 14 and 16 there are provided transfer sealing means 50, best seen in FIG. 4. The transfer sealing means 50 facilitate the rotation of adjacent trommel sections, for example trommel section 12 and trommel section 14, or trommel section 14 and trommel section 16.

The transfer sealing means 50 comprise an annular flexible member 52 retained between adjacent trommel sections and about the circumference thereof. The transfer sealing means 50 further comprises a flexible retaining member 54 and a locating member or ring 56, each extending about the circumference of the trommel sections. The locating member 56 fixes the flexible retaining member 54 in position by pressing outwardly to hold the flexible retaining member 54 against an inner surface of an outer skin of the trommel section. The flexible retaining member 54 locates and retains the annular flexible member 52 in a circumferential recess 58 provided between adjacent trommel sections, for example 12 and 14. The circumferential recess 58 is defined as a channel provided in a rear end of one trommel section, the locating member 56 and the flexible retaining member 54. The transfer sealing means 50 allow for the containment of the MSW passing through the trommel train, facilitate the operation of adjacent trommel sections 12, 14 and 16, at different relative speeds. In addition, the lifting and parking of the trommel sections 12, 14 and 16 is facilitated.

It is envisaged that the transfer sealing means may be provided in essentially the same form as the first end sealing arrangement, wherein adjacent trommel sections form the first and second components, there being relative rotational movement therebetween as the trommel sections are able to rotate at different speeds.

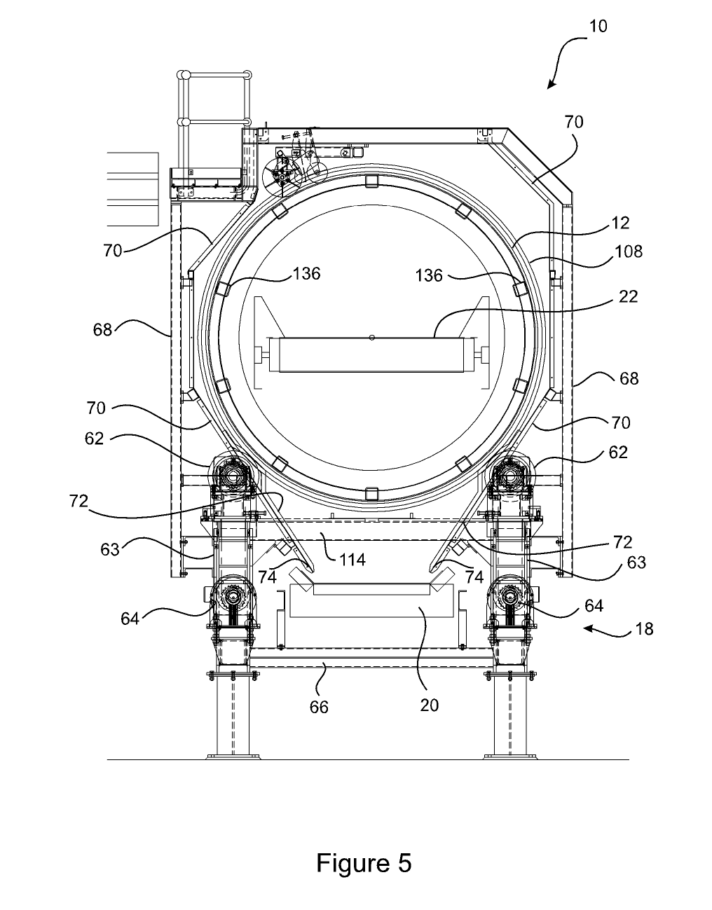

In FIGS. 1 to 3 it can be seen that the trommel sections 12, 14 and 16 have provided thereon circumferential drive wheel tracks 60. Each drive wheel track 60 is aligned with a pair of drive wheels 62 provided on the support frames 18, best seen in FIGS. 5 and 9 to 12.

With reference to FIG. 5, the support frames 18 have provided thereon the pair of drive wheels 62, each driven indirectly by chain drive 63 from driven wheels 64, also supported on the support frames 18. The drive wheels 62 have a polyurethane tread provided thereon, providing friction, damping and noise reduction qualities. It is envisaged that materials other than polyurethane may be utilised for the tread portion to achieve the same or similar results without departing from the scope of the present invention. The drive to the four drive wheels 62 driving each trommel section 12, 14 and 16, is synchronised with one acting as a ‘master’ and the remaining three as ‘followers’.

An intermediate frame 66 on each support frame 18 supports in an operable manner the conveyor 20. In addition, a canopy frame 68 is fixed to the support frame 18 and extends over the trommel section, for example 12, to also be supported on that same support frame 18 at its other side, as is clearly shown in FIG. 5. The canopy frame 68 in turn supports shielding 70 about sides of the trommel sections 12, 14 and 16, and forms chute sides 72 at its lower edges 74 that act to direct screened material from the trommel sections to the conveyor 20.

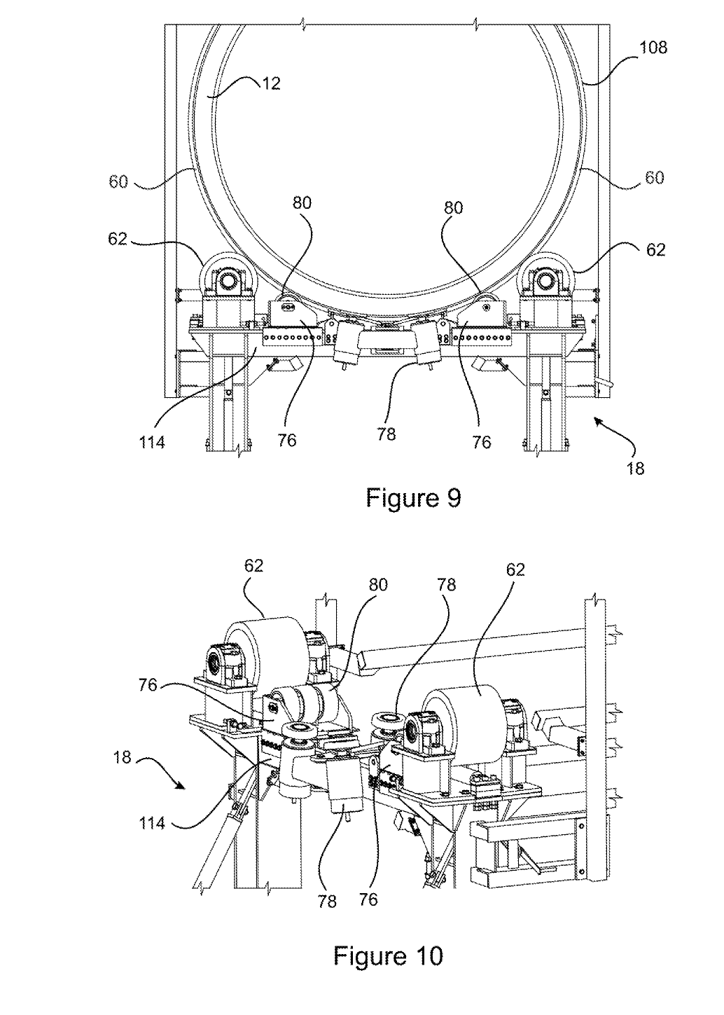

The trommel support arrangements further comprise a pair of opposed idler means 76, and a pair of thrust roller means 78, each provided on the support frames 18, as best seen in FIGS. 9 to 12. The idler means 76 are able to be moved in and out relative to one another. As rollers 80 provided on each idler means 76 may contact the drive wheel tracks 60 of the trommel sections 12, 14 and 16, such a movement inwardly toward one another has the effect of raising the trommel section 12, 14 or 16 off the drive wheels 62.

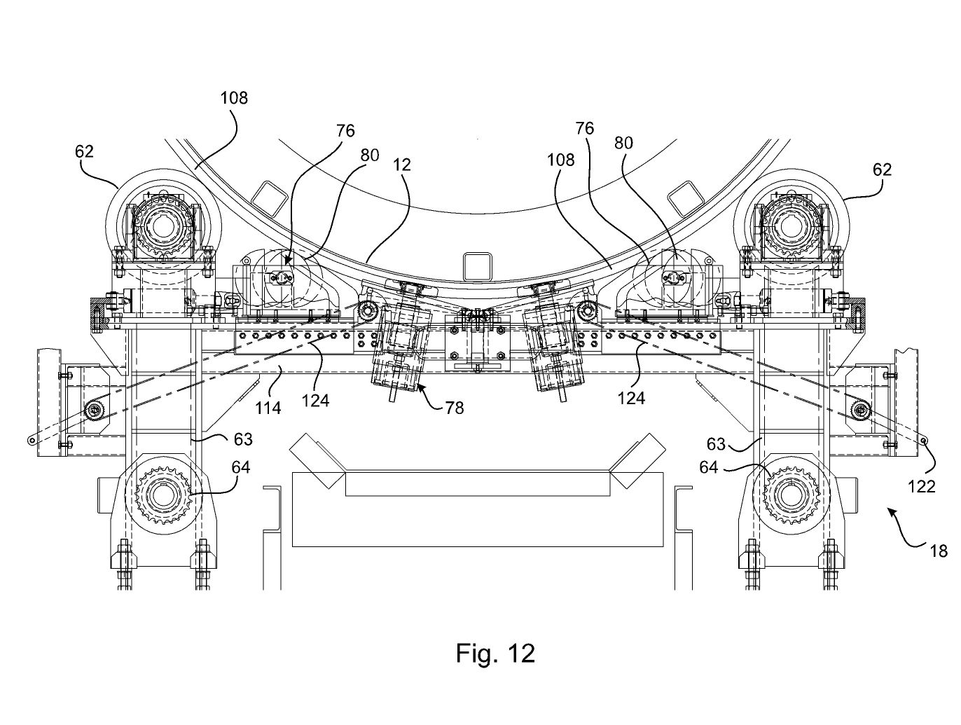

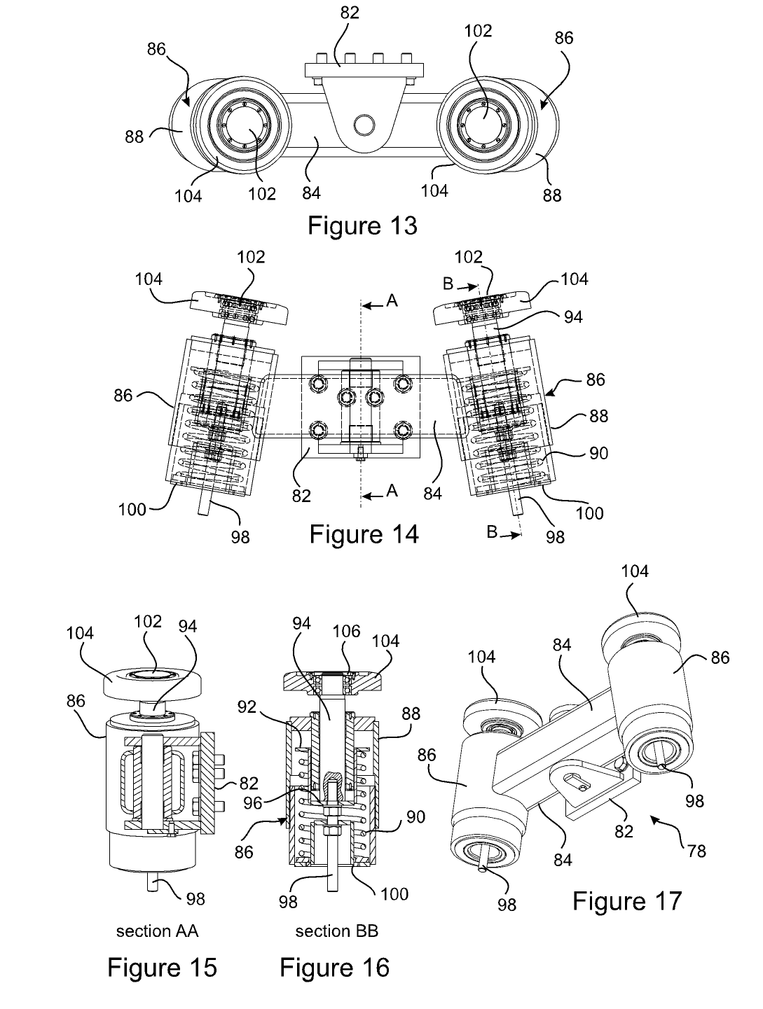

With reference to FIGS. 13 to 17, the thrust roller means 78 comprise a mounting bracket 82 to which an intermediate arm 84 is attached in a pivotal manner. The mounting bracket 82 is affixed to the support frame 18. The intermediate arm 84 has provided at each opposed end thereof a roller module 86. The roller modules 86 are oriented upwardly and inwardly toward one another so as to match the radius of the trommel section 12, 14 or 16 with which it engages. Each roller module 86 comprises a cylinder 88 in which is housed a biasing means, for example a spring 90. The spring 90 supports a collar means 92 that in turn supports a piston member 94. The piston member 94 has a base 96 that receives therein a threaded member 98, the threaded member 98 in turn passing through a recessed base member 100 of the cylinder 88. The piston member 94 further has an outer end 102 about which is provided a wheel 104. The wheels 104 are mounted on the outer end 102 of the piston member 94 by way of several bearings 106. The wheels 104 each bear on circumferential flanges 108 provided about the trommel sections 12, 14 and 16, see FIGS. 9 and 12, and exerting passive, axial resistance, on the trommel sections thereby. Any radial variation in the trommel sections 12, 14 and 16 is accommodated by way of the construction of the thrust roller means 78, in particular the biasing means provided therein. The threaded member 98 provides a level of adjustment in each cylinder 88 in terms of how far the piston member 94 projects outwardly therefrom.

Each idler means 76 comprises a housing 109 in which the rollers 80 are rotatably supported, a pair of guide flanges 110 and a ram 112, as is shown in FIGS. 9 to 12, and 18 to 20. The guide flanges 110 support the housing 109 and act to locate the idler means 76 on an upper lateral member 114 of the support frame 18 and ensure that movement thereof is lateral with respect to the trommel train. The ram 112 has a first end 116 fixed to the housing 109 and a second end 118 fixed to the support frame 18.

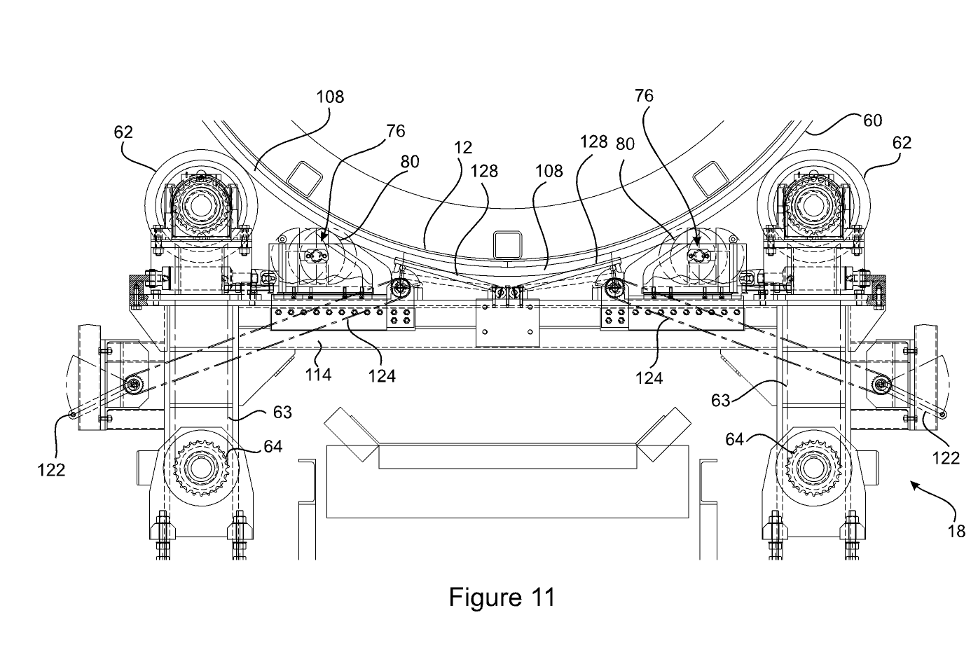

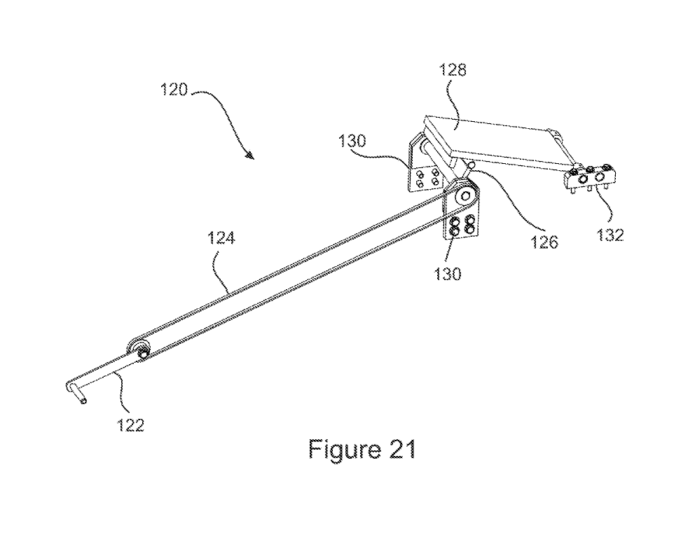

A parking lock means 120 is shown in FIG. 21. The parking lock means 120 comprises an actuating arm 122 that drives a chain link 124, which in turn operates a rotating intermediate arm 126 between an engaged and a disengaged position. In the engaged position, as shown in FIG. 21 specifically, the intermediate arm 126 raises a pivotally mounted parking plate 128. The rotating intermediate arm 126 is mounted between two mounting flanges 130 that are in turn mounted on the upper lateral member 114 of the support frame 18. The parking plate 128 is pivotally mounted by way of mounting stubs 132 that are also in turn mounted on the upper lateral member 114 of the support frame 18. As can be seen with reference to FIGS. 11 and 12, operation of the parking lock means 120 can move the parking plate 128 between positions in which the trommel section 12, 14 or 16 bears thereon, relieving the drive wheels 62 of the weight of the trommel train, and a position in which the parking plate 128 is clear of the rotating trommel train.

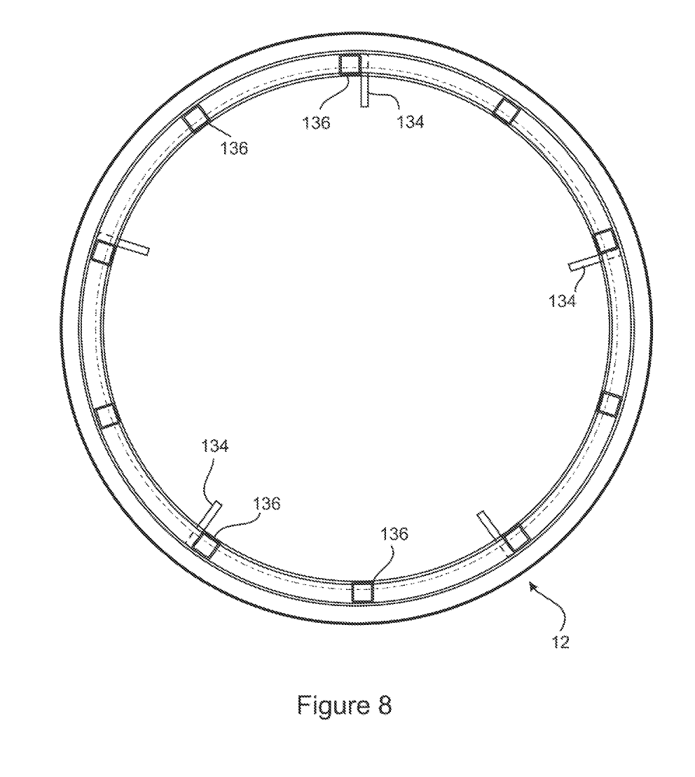

In FIG. 8 there is shown a cross section of a trommel section, for example trommel section 12, showing aspects of the construction thereof. In particular it is shown that a plurality of internal lifting means 134 are provided therein, whereby MSW passing through the trommel sections may be lifted, dropped and broken as the trommel rotates and the MSW passes therethrough. The lifting means 134 extend longitudinally through at least a portion of the trommel train, but are discontinuous, and are mounted to longitudinal support members 136 that define in part each trommel section 12, 14 and 16. The lifting means 134 extend radially a short distance from the support members 136 and are offset relative to one another, or staggered, within each trommel section 12, 14 and 16. The lifting means 134, combined with centrifugal force, lift the MSW passing through the trommel train to a high point, near vertical, to maximise dynamic breakdown of the material. This is accentuated by the fact that the MSW once lifted to the high point falls back onto a portion of the screen largely devoid of MSW at that point in rotation. This process in turn accentuates the maceration of the MSW, and the splitting and emptying of bags. In turn, the efficiency of screening of the MSW is also increased relative to trommel designs in which the MSW is not lifted to near vertical by rotation of the trommel train.

It is envisaged that the incorporation of the lifting means 134 allows the apparatus 10 of the present invention to be operated at slower rotational speeds than trommel designs of the prior art. The operation at relatively lower speeds than those of the prior art allows smaller drive motors to be utilised, which in turn results in reduced energy consumption and wear of drive components.

With reference to FIG. 3 it can be seen that the first trommel section 12 has, adjacent the first end 24 thereof, a substantially solid shell portion 140. Of the solid shell portion 140 an initial portion thereof is provided as a screw bladed portion 142, having helically disposed flutes arranged therein, whereby waste entering the first trommel section 12 is moved a distance into the first trommel 12 at first instance in a relatively quick fashion compared to subsequent slower travel through the trommel train. The remainder of the first trommel section 12, for example about 50% thereof, is provided with a series of circumferential screens 144, through which appropriately sized MSW may pass, other than for the circumferential drive wheel tracks 60 provided thereabout.

In addition, the solid shell portion 140 of the first trommel section 12 has spray means, for example water sprays 143, provided therein whereby the MSW passing therethrough may be wetted or moistened, aiding in the breakdown of certain materials within the MSW, including cardboard for example. The incorporation of the spray means in the solid shell portion 140 ensures that water, for example, is not lost through a screen but is rather absorbed by the MSW. Additionally, the addition of water is arranged so as to expose falling MSW, falling as a result of the rotation of the first trommel section 12, to water which results in thorough wetting of the MSW. The result achieved is understood to be more effective than that achieved by simply applying water to a mass of MSW material.

The addition of water by way of the water sprays 143 is conducted in a measured and adjustable manner. The flow of water is metered, measuring water flow in litres per minute. A valve means (not shown) is provided by which the flow of water is controlled, the valve means in turn being governed at least in part by signals received from a process control system (not shown). The volume of water added by way of the water sprays 143, i.e. the water flow, is adjusted in accordance with the volume of MSW added to the first trommel section 12 by way of the conveyor 22. Additionally, the volume of water added may also be determined by the specific nature of the material mix in the MSW, at an operator's discretion.

The trommel section 14, arranged intermediate to the trommel sections 12 and 16, is provided with almost its entire surface as circumferential screens 146, other than for the drive wheel tracks 60 provided thereabout. Further, the trommel section 16 has about 70% of its surface provided as circumferential screens 148 having apertures of the same size, less than about 60 mm, for example 40 mm, as the screens 144 and 146. A terminal portion of the trommel section 16 is provided as a relatively coarse screen 150, with apertures of less than about 300 mm, for example about 200 mm, through which most remaining items from the MSW will pass to a conveyor 152 by which those items are directed elsewhere, with any large items that do not pass through the screens 144, 146, 148 and 150, being discharged therefrom into a chute 154 to be directed elsewhere.

The method produces each of a fine mixed fraction, a coarse mixed fraction and an oversized mixed fraction from the MSW.

The fine mixed fraction and the coarse mixed fraction contain both organic and inorganic materials. The oversized mixed fraction may be optionally further separated into at least two sub-fractions, of which the larger fraction will be rejects.

As noted above, the fine mixed fraction is of a size smaller than or equal to about 60 mm. Further, the coarse mixed fraction is of a size smaller than or equal to about 250 mm. Still further, the oversized mixed fraction is of a size greater than 300 mm.

A serrated discharge disc or blade (not shown) is provided at the terminal portion of the trommel section 16. The disc or blade assists in the handling of rejects in the form of cords or other long, perhaps ‘stringy’ items.

The MSW passing through the screens 144, 146, 148 and 150 of respective trommel sections 12, 14 and 16 in the trommel train is about 20%, 30% and 30% by volume, respectively, with the remainder passing through the trommel train to discharge chute 154.

The trommel train is arranged on a gradual and smooth decline of between about 0 to 5°, for example 1°, from the first end 24 of the first trommel section 12 to the terminal portion of the third trommel section 16, thereby facilitating the passage of the MSW therethrough. The trommel sections 12, 14 and 16 may be arranged independently to decline at differing angles with respect to the remaining trommel sections. For example, one trommel section may decline at 1° whilst another is set at near 0°.

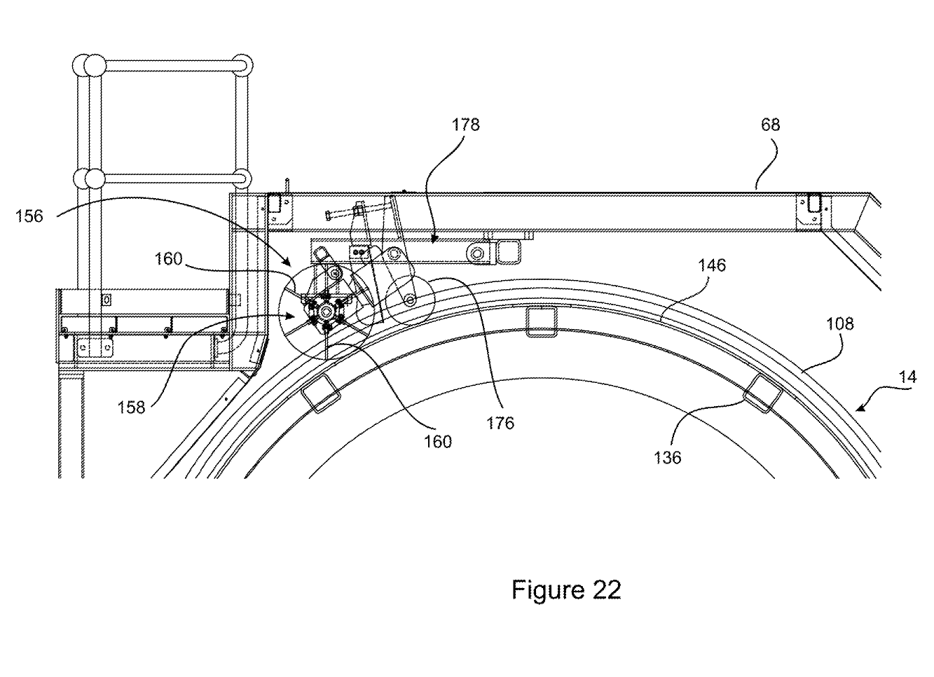

The apparatus 10 for separating solid waste material of the present invention further comprises at least one screen cleaning means 156, as shown in FIG. 22, by way of which at least portions of the rotating screens employed in the trommel train may be cleaned to free the apertures therein from clogged MSW, there being relative movement or rotation of the screens with respect to the or each screen cleaning means. With reference to FIGS. 22 to 33, the screen cleaning means 156 is mounted on the canopy frame 68 such that it can impinge upon, for example, the screen 146 of the trommel section 14. The screen cleaning means 156 comprises an elongate paddle wheel 158 on which are provided a plurality of resilient screeds 160. The screen cleaning means 156 further comprises a drive assembly 162 and an idler wheel assembly 164.

The paddle wheel 158 further comprises a central shaft 166 driven to rotate by the drive assembly 162, in a direction counter to the rotation of the trommel section in combination with which it is used. The screeds 160 are mounted radially to the shaft 166 between support mounts 168. A trailing face 170 of the support mounts 168, relative to the direction of rotation of the paddle wheel 158, is provided with an arcuate lip 172. The trailing face 170 and arcuate lip 172 act to support the screeds 160 as they flex rearwardly during the screen cleaning process, this arrangement being typical of a situation in which the paddle wheel 158 and the trommel section in combination with which it is used, rotate in opposed directions.

It is envisaged that if the paddle wheel 158 is rotated in the same direction as the trommel section in combination with which it is used, and at a slower linear speed relative thereto, the screeds 160 will flex in the opposite direction than when the paddle wheel 158 rotates at a faster linear speed than the trommel section in combination with which it is used. In effect the screeds 160 will flex forwardly. This demands a modification in structure of the paddle wheel 158 in which the arcuate lip 172 is positioned on the non trailing face, being in this arrangement the side of the support mount to which the screed flexes. If the paddle wheel is rotated in the same direction as the trommel section in combination with which it is used, but at a higher linear speed relative thereto, then the arrangement will be as described hereinabove with reference to FIGS. 22 to 25 with the screeds 160 flexing rearwardly.

The drive assembly 162 comprises a drive motor 174 that drives the shaft 166, and a support wheel 176 and support frame 178. The support wheel 176 is arranged to run on a trommel section, for example trommel section 14. The support frame 178 has provided thereon an adjustment means 180 by which the position of the paddle wheel 158 relative to the screen 146 may be adjusted. That is, it allows the level of engagement therebetween to be adjusted, in turn adjusting the level of cleaning being administered and the level of wear being endured by the screeds 160.

The adjustment means 180 incorporate flexibly resilient means 181, for example washers 181, to provide vibration damping and noise reduction.

The linear speed of the screen cleaning means 156 is envisaged to be between near 0 to 3 or more times the linear speed of the trommel section in combination with which it is used.

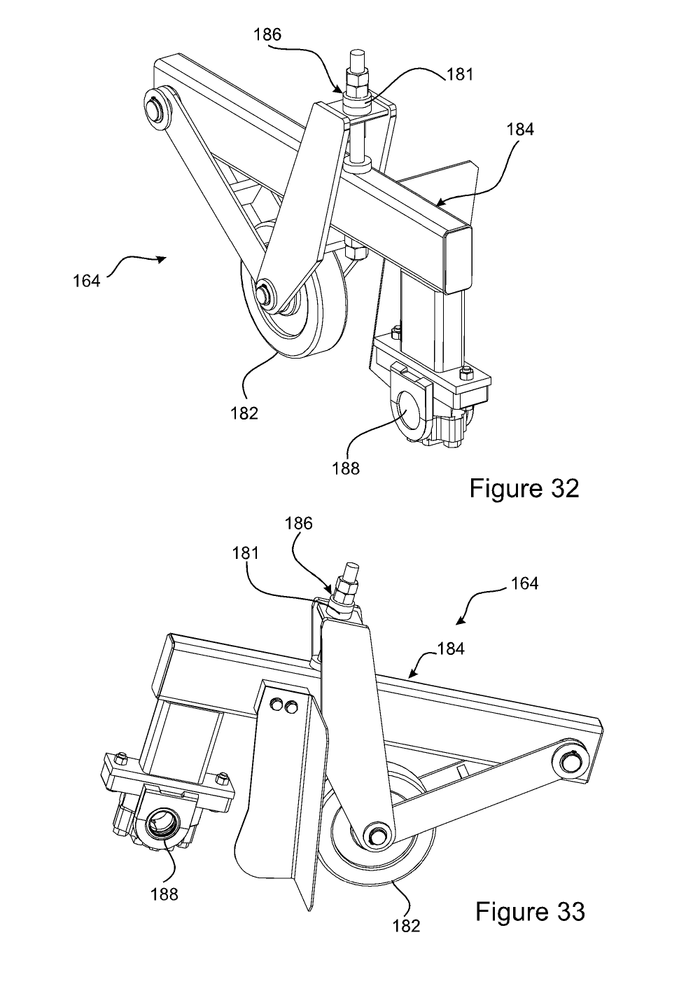

In FIGS. 32 and 33 there is shown the idler assembly 164 comprising an idler wheel 182, a support frame 184, an adjustment means 186. The support frame further provides a mounting 188 for the shaft 166 of the paddle wheel 158. The idler assembly 164 supports the paddle wheel 158 relative to the screen 146, for example. The adjustment means 186 operates in the same manner and with the same function as the adjustment means 180 described hereinabove.

In use, the trommel sections 12, 14 and 16 are operated at differing speeds. It is envisaged that the earlier trommels in the trommel train will rotate at a higher speed than those later in the train in most circumstances. For example, the first trommel section 12 may rotate at a speed of up to about 25 rpm, in one form at between about 9 to 16 rpm. The second trommel section 14 may rotate at less than about 9 to 16 rpm and the third trommel section 16 may rotate at a still lower speed. It is to be understood that two or more of the trommel sections may be run at the same speed should circumstances require it without departing from the scope of the present invention.

It is envisaged that whilst the elongate paddle wheel of the screen cleaning means described above rotates in a direction opposed to that of the or each screen to be cleaned, the paddle wheel and the or each screen to be cleaned may rotate in the same direction but at different speeds thereby also achieving the wiping of material from the screen. The differential speed is such that material on the screen can be dislodged.

It is understood that the apparatus and method of the present invention consume a significantly lower level of power in operation when compared with prior art apparatus and methods, such as slurry separation techniques, composting trommels and autoclaves. Further, the apparatus and method of the present invention provides a lower level of water consumption when compared with prior art apparatus and methods, such as slurry separation techniques and autoclaves. The apparatus and method of the present invention are significantly more time efficient in operation when compared with prior art apparatus and methods, such as composting trommels.

Modifications and variations such as would be apparent to the skilled addressee are considered to fall within the scope of the present invention.

1-68. (canceled)

69. An apparatus for solid waste separation comprising at least two rotatable trommel sections arranged such that solid waste to be separated can be passed through one trommel section and into the other, the trommel sections each having provided therein screens through which screened material may pass and thereby leave the trommel sections, wherein at least two of the trommel sections are capable of rotating at different relative speeds.

70. An apparatus according to claim 69, wherein the screen in a first trommel section is finer than the screen provided in a second trommel section.

71. An apparatus according to claim 69, wherein a first portion of the screen in the first trommel section is solid, without apertures.

72. An apparatus according to claim 70, wherein apertures provided in the screen of the first trommel section are less than or equal to about 60 mm diameter.

73. An apparatus according to claim 70, wherein the first trommel section has provided therein immediately adjacent the first end thereof a screw bladed portion whereby waste entering the first trommel section is moved a distance into the first trommel section at first instance.

74. An apparatus according to claim 69, wherein a final trommel section has provided therein a length of terminal screen that is coarser than the screen utilised in the remainder of the final trommel section and other trommel sections.

75. An apparatus according to claim 69, wherein there are provided three trommel sections.

76. An apparatus according to claim 75, wherein the waste discharged through the screens provided in each trommel in such an arrangement is about 20%, 30% and 30% by volume of the waste fed to the trommels respectively, the remainder being passed from the final trommel.

77. An apparatus according to claim 74, wherein the apertures in the final trommel section are less than or equal to about 300 mm.

78. An apparatus according to claim 69, wherein the trommel sections are provided with internal lifting means whereby the waste passing therethrough is lifted as the trommel sections rotate before falling back to impact on the screens provided therein.

79. An apparatus according to claim 69, wherein one or more of the trommel sections are arranged at a decline to facilitate passage of waste therethrough.

80. An apparatus according to claim 70, wherein the first trommel is provided with spray means whereby the solid waste passing therethrough may be wetted or moistened.

81. An apparatus according to claim 69, wherein the rotation of each trommel section is separately driven.

82. An apparatus according to claim 81, wherein each trommel section is supported on four drive wheels, whereby the load of the trommel section is shared therebetween and wherein each of the four drive wheels is driven individually in a synchronised manner.

83. An apparatus according to claim 81, wherein idler means and thrust roller means are further provided, wherein the idler means allows the weight of the trommel section to be borne thereby and the trommels lifted, relieving the drive wheels of the weight of the trommel section, and the thrust roller means operating to impart passive resistance to aid in locating the trommel section on the drive wheels.

84. An apparatus according to claim 81, wherein a parking lock means is further provided, whereby the drive wheels may be relieved of weight when the trommel sections are not rotating and are at rest, thereby preventing flat spots developing on the drive wheels.

85. An apparatus according to claim 70, wherein the first trommel section rotates at a faster rate than the second trommel section.

86. An apparatus according to claim 69, wherein the apparatus for solid waste separation further comprises transfer sealing means provided between the trommel sections, the transfer sealing means between trommel sections facilitating the rotation of the trommel sections at relatively different speeds whilst maintaining the integrity of the seal.

87. An apparatus according to claim 86, wherein the transfer sealing means comprises an annular flexible member retained between adjacent trommel sections and about the circumference thereof, and a flexible retaining member and a locating member, each extending about the circumference of the trommel sections, wherein the locating member fixes the flexible retaining member in position whereby the flexible retaining member locates and retains the annular flexible member in position.

88. An apparatus according to claim 69, wherein the apparatus for separation of solid waste further comprises a conveyor means provided substantially underneath the trommel sections such that material screened by the trommel sections may be received on the conveyor means.

89. An apparatus according to claim 70, wherein a first end of the first trommel is provided with an end cap in which is provided a slot by which municipal solid waste may be fed to the first trommel.

90. An apparatus according to claim 70, wherein a first end of the first trommel is provided with a first end sealing arrangement that facilitates the rotation of the first trommel relative to the end cap.

91. An apparatus according to claim 90, wherein the first end sealing arrangement comprises a raised annular portion provided on the first end of the first trommel and a dual leaf annular member provided on the end cap, wherein the raised member is received between the leaves of the dual leaf annular member thereby forming a substantially tight seal.

92. An apparatus according to claim 69, the apparatus further comprising one or more screen cleaning means arranged to impinge upon the screens of the or each trommel thereby removing material that may be clogging or otherwise interfering with the operation of same.

93. An apparatus according to claim 92, wherein the screen cleaning means comprises an elongate paddle wheel on which is provided a plurality of resilient screeds, the paddle wheel being rotatable about its length such that the screeds impinge upon the screens of the trommel section in a manner that facilitates the wiping of material from the screens.

94. An apparatus according to claim 74, wherein the final trommel has a serrated discharge disc provided at a terminal portion thereof, whereby the handling of rejects is facilitated.

95. A method for the separation of solid waste, the method comprising the steps of passing a solid waste to a series of at least two rotating trommel sections, the trommel sections being arranged such that the solid waste to be separated can be passed through one trommel section and into the other, the trommel sections each having provided therein screens through which screened material may pass and thereby leave the trommel sections, wherein at least two of the trommel sections are capable of rotating at different relative speeds.

96. A method according to claim 95, wherein the method for the separation of solid waste does not require material handling between the trommel sections.

97. A method according to claim 95, wherein the method further comprises the step of wetting or moistening the solid waste.

98. A method according to claim 95, wherein the method produces each of a fine mixed fraction, a coarse mixed fraction and an oversized mixed fraction from a municipal solid waste.

99. A method according to claim 98, wherein the fine mixed fraction and the coarse mixed fraction contain both organic and inorganic materials.

100. A method according to claim 98, wherein the fine mixed fraction is of a size smaller than or equal to about 60 mm, the coarse mixed fraction is of a size smaller than or equal to about 300 mm, and the oversized mixed fraction is of a size greater than 300 mm.
